(19) United States
(12) Patent Application Publication
(10) Pub. No.: US 2009/0008341 A1
(43) Pub. Date: Jan. 8, 2009

(54) FLUID REMOVING FILTER APPARATUS AND METHOD OF REMOVING FLUID FROM A MIXTURE

(75) Inventors: Paul S. Townson, Richland, WA (US); Jeffrey T. Prince, Richland, WA (US)

Correspondence Address: HOLLAND & HART LLP, 60 E. South Temple, Suite 2000, P.O. Box 11583, Salt Lake City, UT, 84110, US

(73) Assignee: EnergySolutions Diversified Services, Inc., Columbia, SC (US)

(21) Appl. No.: 12/166,897

(22) Filed: Jul. 2, 2008

Related U.S. Application Data
(60) Provisional application No. 60/958,386, filed on Jul. 5, 2007.

(51) Int. Cl. B01D 35/30; B01D 29/13; B01D 29/56

(52) U.S. Cl. 210/767; 210/336; 210/323.2; 210/337

(57) ABSTRACT

A filter assembly having a proximal end portion and a distal end portion is described. The filter assembly may include a feed inlet located at the proximal end portion and a first filter element in fluid communication with the feed inlet, the first filter element extending between the proximal end portion and the distal end portion of the filter assembly. Additionally, the filter assembly may include a second filter element in fluid communication with the first filter element, the second filter element extending between the distal end portion and the proximal end portion of the filter assembly. The filter assembly may also include a flow deflector located at the distal end portion of the filter assembly, the flow deflector being configured to deflect a flowable mixture exiting the first filter element toward the second filter element. The filter assembly may additionally include a retentate outlet located at the proximal end portion of the filter assembly, the retentate outlet being in fluid communication with the second filter element. A method of removing liquid from a flowable mixture is also disclosed.

### CROSS REFERENCE TO RELATED APPLICATION

This application claims the priority benefit of U.S. Provisional Application No. 60/958,386, filed Jul. 5, 2007, the disclosure of which is incorporated, in its entirety, by this reference.

### BACKGROUND

During processing of various waste products, including hazardous waste products, the waste is often dewatered to various extents. Dewatering is a process of removing water from waste products, such as a sludge or slurry waste product. Dewatering waste may make waste more manageable and may lower transportation and disposal costs for the waste. Additionally, dewatering waste may help reduce storage volumes required for the waste and may reduce leachate from the waste. A conventional method of dewatering waste may include the use of a filter to remove water from the waste. A conventional filter unit may comprise a relatively long filter element. As a waste mixture flows through the filter element, liquid portions of the waste mixture may pass through pores in the filter element.

A more compact filter unit may be constructed to reduce the length taken up by a filter unit by positioning the filter inlet and outlet in close proximity to each other at a first end of the filter unit. The filter unit may pass a waste mixture in a first direction away from the filter inlet through a length of non-filtering pipe toward a second end of the filter unit, at which point the waste mixture may strike an end surface of the filter unit, where the waste mixture may experience significant turbulence. The waste mixture may then be reversed in direction toward the first end of the filter unit, flowing through filtering elements toward the outlet. As the waste mixture passes through the length of non-filtering pipe toward the second end, and as the waste mixture subsequently strikes the end surface at the second end of the filter unit, the waste mixture may experience substantial frictional losses. Frictional losses may significantly reduce the flow rate of a waste mixture as it passes through the filter unit, particularly in the case of non-Newtonian mixtures. Additionally, while a more compact filter unit may reduce the amount of space used by the filter unit in comparison with a longer filter unit, the more compact filter unit may be reduced in overall filtering efficiency due to decreased filtering surface area.

### SUMMARY

According to at least one embodiment, a filter assembly may comprise a first filter element comprising an elongated member having an inlet portion and an outlet portion. The filter assembly may also comprise a second filter element that includes an elongated member having an inlet portion and an outlet portion. The second filter element may be laterally adjacent the first filter element. The filter assembly may additionally comprise a flow deflector configured to deflect a flowable mixture exiting the outlet portion of the first filter element toward the inlet portion of the second filter element. The filter assembly may further comprise a permeate chamber surrounding at least a portion of at least one of the first filter element and the second filter element.

According to additional embodiments, a filter assembly may comprise a proximal end portion and a distal end portion. A feed inlet may located at the proximal end portion of the filter assembly. The filter assembly may also comprise a first filter element in fluid communication with the feed inlet, the first filter element extending between the proximal end portion and the distal end portion. Additionally, the filter assembly may comprise a second filter element in fluid communication with the first filter element, the second filter element extending between the distal end portion and the proximal end portion of the filter assembly. Further, the filter assembly may comprise a flow deflector located at the distal end portion of the filter assembly, the flow deflector being configured to deflect a flowable mixture exiting the first filter element toward the second filter element. The filter assembly may additionally comprise a retentate outlet located at the proximal end portion of the filter assembly, the retentate outlet being in fluid communication with the second filter element.

According to various embodiments, a filter assembly may comprise a first plurality of porous tubes configured to convey a flowable mixture in a first direction and a second plurality of porous tubes in fluid communication with the first plurality of porous tubes, the second plurality of porous tubes being configured to convey the flowable mixture in a second direction. The filter assembly may also comprise a flow deflector configured to deflect a flowable mixture exiting the first plurality of porous tubes toward the second plurality of porous tubes. Additionally, the filter assembly may comprise a permeate chamber surrounding at least a portion of at least one of the first plurality porous tubes and the second plurality of porous tubes, the permeate chamber being configured to convey a permeate from at least one of the first plurality of porous tubes and the second plurality of porous tubes.

According to certain embodiments, a filter assembly may comprise an elongated housing having a central axis, a proximal end portion, and a distal end portion, the elongate housing including a first filter element positioned in the elongate housing about the central axis. The elongate housing may also include a second filter element positioned in the elongate housing such that at least part of the second filter element surrounds the first filter element in a radial direction relative to the central axis. The elongate housing may also comprise a deflection chamber in the distal end portion between an end surface of the elongate housing and each of the first filter element and the second filter element. Further, the elongate housing may comprise a flow deflector positioned in the deflection chamber, the flow deflector being configured to deflect a flowable mixture from the first filter element toward the second filter element.

According to at least one embodiment, a method of removing liquid from a flowable mixture may comprise conveying the flowable mixture through a first filter element in a first direction and deflecting the flowable mixture exiting the first filter element toward a second filter element inlet. The method may also comprise conveying the flowable mixture through the second filter element in a second direction substantially opposite the first direction. Additionally, the method may comprise conveying a permeate from the flowable mixture through a porous surface of at least one of the first filter element and the second filter element into a permeate chamber surrounding at least a portion of at least one of the first filter element and the second filter element.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a side view of an exemplary filter apparatus according to at least one embodiment.

FIG. 2 is a cross-sectional side view of an exemplary filter apparatus according to additional embodiments.

FIG. 3 is a perspective view of an exemplary deflection member according to at least one embodiment.

FIG. 4 is a cross-sectional side view of an exemplary deflection member according to additional embodiments.

FIG. 5 is a cross-sectional side view of an exemplary filter apparatus according to additional embodiments.

FIG. 6 is a cross-sectional side view of an exemplary filter apparatus according to additional embodiments.

FIG. 7 is a cross-sectional side view of an exemplary filter apparatus according to additional embodiments.

FIG. 8 is side view of a portion of a filter tube in a permeate chamber of an exemplary filter apparatus according to at least one embodiment.

FIG. 9 is a cross-sectional top view of an exemplary filter apparatus according to additional embodiments.

FIG. 10 is a cross-sectional perspective view of portions of an exemplary filter apparatus, including filters tubes, tubesheets, and a flow deflector according to at least one embodiment.

FIG. 11 is a bottom view of an exemplary tubesheet according to at least one embodiment.

FIG. 12 is a side view of more than one exemplary filter apparatus connected in series according to at least one embodiment.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

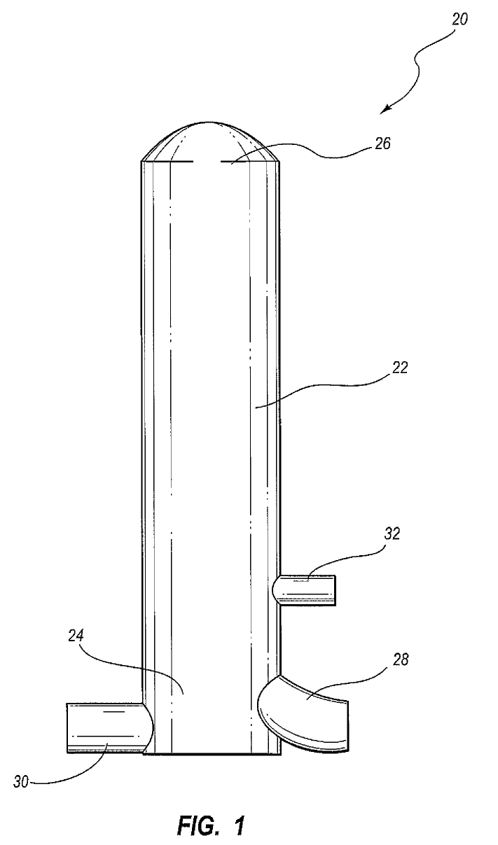

FIG. 1 is an exemplary filter apparatus 20 according to at least one embodiment. As illustrated in this figure, filter apparatus 20 may comprise a housing 22, a proximal end portion 24 and a distal end portion 26. Filter apparatus 20 may additionally comprise a feed inlet 28, a retentate outlet 30, and a permeate outlet 32. Housing 22 may be formed in any suitable shape or size and of any suitable material or combination of materials. For example, housing 22 may comprise a generally cylindrical shape that may be elongated. Additionally, housing 22 may comprise any suitable shape or size at proximal end portion 24 and/or distal end portion 26, including, for example, a rounded end portion and/or a flattened end portion. Filter apparatus 20 may be oriented in any suitable configuration. For example, filter apparatus 20 may be oriented with proximal end portion 24 disposed under distal end portion 26.

Feed inlet 28 may comprise an inlet opening and/or passage in filter apparatus 20 configured to accept a flowable feed mixture to be filtered by filter apparatus 20. For example, as shown in FIG. 1, feed inlet may comprise a pipe extending into an interior of housing 22. Suitable feed materials may include, without limitation, a slurry, a sludge, a liquid mixture, a gaseous mixture, and/or any other suitable fluid and/or solid mixture. A slurry may comprise a mixture of liquid carrier and one or more dissolved and/or non-dissolved solid components. A slurry may additionally comprise non-dissolved solid components in the form of solid particles. Suitable slurries may exhibit characteristics of Newtonian and/or non-Newtonian fluids. According to various embodiments, a suitable slurry may include a waste slurry that is to be reduced in water content (e.g., dewatered). Various slurries may also comprise various hazardous and/or radiological waste materials.

Retentate outlet 30 may comprise an outlet opening and/or passage in filter apparatus 20 configured to discharge a retentate of a flowable mixture from filter apparatus 20. For example, as shown in FIG. 1, retentate outlet 30 may comprises a pipe extending from an interior of housing 22. In addition, permeate outlet 32 may comprise an outlet opening and/or passage in filter apparatus 20 configured to discharge a permeate of a flowable mixture from filter apparatus 20. For example, as shown in FIG. 1, permeate outlet 32 may comprises a pipe extending from an interior of housing 32. A permeate exiting through permeate outlet 32 may comprise a portion of a mixture that passes through pores in a filter wall or membrane in filter apparatus 20, exiting filter apparatus 20 through permeate outlet 32. A permeate may primarily or entirely comprise a fluid solution that may include dissolved components. A retentate may be a portion of a flowable mixture exiting filter apparatus 20 through retentate outlet 30 that does not pass through pores in a filter wall or membrane in filter apparatus 20. According to at least one embodiment, a retentate exiting filter apparatus 20 through retentate outlet 30 may comprise a portion of a flowable mixture that does not exit filter apparatus through permeate outlet 32. A retentate exiting through retentate outlet 30 may comprise fluid components and/or solid components.

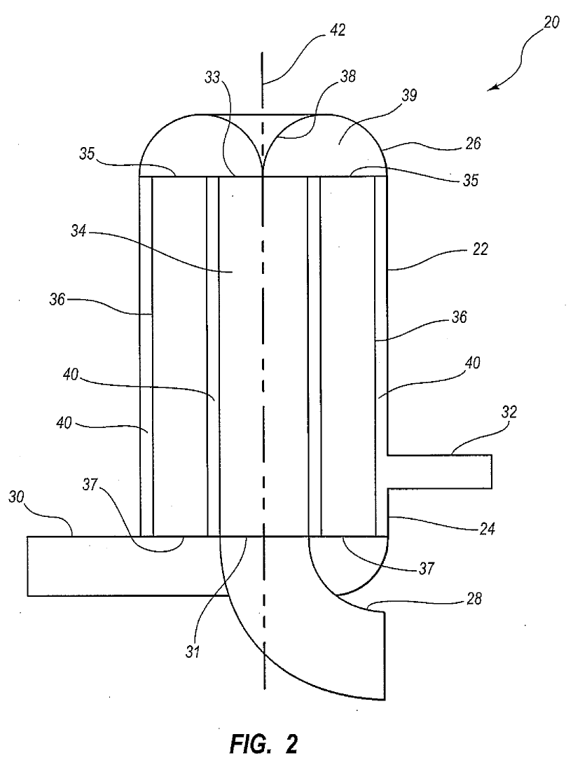

FIG. 2 is an exemplary filter apparatus 20 according to various embodiments. As illustrated in this figure, filter apparatus 20 may comprise a housing 22, a proximal end portion 24, a distal end portion 26, a feed inlet 28, a retentate outlet 30, and a permeate outlet 32, as described above. In addition, filter apparatus 20 may comprise a first filter element 34, a second filter element 36, and a flow deflector 38. According to additional embodiments, at least a portion of first filter element 34 and/or second filter element 36 may be surrounded by a permeate chamber 40. Additionally, flow deflector 38 may comprise a surface portion of a deflection chamber 39, as shown. Filter apparatus 20 may be oriented in any suitable configuration. For example, filter apparatus 20 may be oriented with proximal end portion 24 disposed under distal end portion 26 such that first filter element 34 and/or second filter element 36 extend substantially vertically between proximal end portion 24 and distal end portion 26.

First filter element 34 may comprise a first filter inlet portion 31 located at or near proximal end portion 24 of filter apparatus 20 and a first filter outlet portion 33 located at or near distal end portion 26 of filter apparatus 20. Further, second filter element 36 may comprise a second filter inlet portion 35 located at or near distal end portion 26 of filter apparatus 20 and a second filter outlet portion 37 located at or near proximal end portion 24 of filter apparatus 20. First filter inlet portion 31, first filter outlet portion 33, second filter inlet portion 35, and/or second filter outlet portion 37 may comprise an end portion of first filter element 34 and/or second filter element 36. In additional embodiments, first filter inlet portion 31, first filter outlet portion 33, second filter inlet portion 35, and/or second filter outlet portion 37 may comprise a separation region between first filter element 34 and/or second filter element 36 and any of feed inlet 28, retentate outlet 30, and/or deflection chamber 39. For example, first filter inlet portion 31, first filter outlet portion 33, second filter inlet portion 35, and/or second filter outlet portion 37 may comprise a portion of a tubesheet located at and/or adjacent to an end portion of first filter element 34 and/or second filter element 36.

First filter element 34 and second filter element 36 may each comprise any type or form of filter element suitable for filtering a flowable mixture, such as, for example, a slurry. In addition, first filter element 34 and/or second filter element 36 may comprise one or more filtering components capable of filtering a flowable mixture, such as, for example, one or more porous filter tubes and/or one or more filter channels comprising porous walls and/or membranes. According to various embodiments, first filter element 34 may enclose a volume of a flowable mixture that is substantially equivalent to a volume of a flowable mixture that second filter element 36 is capable of enclosing. In additional embodiments, first filter element 34 may be capable of enclosing a different volume of a flowable mixture than second filter element 36.

Additionally, first filter element 34 and/or second filter element 36 may be configured to allow a flowable mixture to pass through one or more portions of first filter element 34 and/or second filter element 36. As a flowable mixture passes through one or more portions of first filter element 34 and/or second filter element 36, first filter element 34 and/or second filter element 36 may allow a fluid portion of the flowable mixture to pass from the flowable mixture in first filter element 34 and/or second filter element 36 into permeate chamber 40.

In various embodiments, first filter element 34 and/or second filter element 36 may comprise porous layers or walls separating a flowable mixture passing through first filter element 34 and/or second filter element 36 from permeate chamber 40, a fluid portion of the flowable mixture being capable of passing through pores in the porous layers or walls into permeate chamber 40. According to additional embodiments, first filter element 34 and/or second filter element 36 may comprise porous layers or walls having pores sized to prevent solid portions of a flowable mixture, such as solid particles, from passing through the porous layers or walls into permeate chamber 40.

According to certain embodiments, first filter element 34 and/or second filter element 36 may be removable from housing 22. For example, first filter element 34 and/or second filter element 36 may together form a filter cartridge that may be installed in housing 22, and that may later be removed and/or replaced. In additional embodiments, first filter element 34 and/or second filter element 36 may be formed as a single fabricated unit with housing 22.

As illustrated in FIG. 2, housing 22 may have a central axis 42 running longitudinally through a central or substantially central portion of housing 22 and/or filter apparatus 20. Additionally, housing 22 may comprise an elongate housing substantially centered around central axis 42 in a longitudinal orientation. First filter element 34 and/or second filter element 36 may be positioned within housing 22 substantially parallel to central axis 42 in a longitudinal direction. First filter element 34 and/or second filter element 36 may also be positioned about central axis 42. For example, as shown in FIG. 2, first filter element 34 may be positioned such that central axis 42 runs longitudinally through a central portion of first filter element 34.

Additionally, second filter element 36 may be positioned around first filter element 34, as illustrated in FIG. 2. For example, second filter element 36 may radially surround at least a portion of first filter element 34 relative to central axis 42. According to additional embodiments, second filter element 36 may be positioned such that central axis 42 runs longitudinally through a central portion of second filter element 36, and first filter element 34 radially surrounds second filter element 36 relative to central axis 42. According to certain embodiments, first filter element 34 may be adjacent to second filter element 36 in such a configuration that the first filter element 34 does not radially surround a portion of second filter element 36 and second filter element does not radially surround a portion of first filter element 34.

Permeate chamber 40 may surround various portions of first filter element 34 and/or second filter element 36, and additionally, permeate chamber 40 may extend through a portion of first filter element 34 and/or second filter element 36. Permeate chamber 42 may also extend between first filter element 34 and second filter element 36 and/or between filter components forming first filter element 34 and/or second filter element 36. Permeate outlet 32 may be connected to permeate chamber 40 such that a permeate in permeate chamber 40 may be discharged from filter apparatus 20 through permeate outlet 32.

First filter element 34 may extend longitudinally through a portion of filter apparatus 20 between feed inlet 28 and deflection chamber 39. Accordingly, a flowable feed mixture entering filter apparatus 20 through feed inlet 28 may be conveyed from feed inlet 28 though first filter element 34 to deflection chamber 39. Flow deflector 38 may form at least a portion of a surface of deflection chamber 39. Flow deflector 38 may be configured to deflect a flow entering deflection chamber 39 from first filter element 34 toward second filter element 36. For example, flow deflector 38 may be configured to deflect a flow exiting first filter outlet portion 33 adjacent deflection chamber 39 toward second filter inlet portion 35 adjacent deflection chamber 39.

According to various embodiments, flow deflector 38 may comprise an annular trough having an annular concave surface open to first filter outlet portion 33 and/or second filter inlet portion 35. An outer portion of the annular concave surface of flow deflector 38 may slope radially outward with respect to central axis 42. In addition, an inner portion of the annular concave surface of flow deflector 38 may slope radially inward with respect to central axis 42 to form a protrusion. According to at least one embodiment, a protrusion formed on flow deflector 38 may substantially extend along central axis 42 toward first filter element 34 and/or second filter element 36.

According to additional embodiments, second filter element 36 may extend longitudinally through a portion of filter apparatus 20 between deflection chamber 39 and retentate outlet 30. Accordingly, a flowable feed mixture entering second filter element 36 from deflection chamber 39 may be conveyed from second filter inlet portion 35 though second filter element 36 to retentate outlet 30, which is connected to second filter element 36 and which is open to second filter outlet portion 37.

Filter apparatus 20 having both first filter element 34 and second filter element 36 may operate with significantly increased filtering efficiency in comparison with a filter apparatus that is merely configured to pass a flowable mixture through a filter element or set of filter tubes in only a single direction. For example, filter apparatus 20 having both first filter element 34 and second filter element 36 may substantially increase the filter surface area to which a flowable mixture is exposed as it passes through filter apparatus. Accordingly, a flowable mixture may be filtered as it passes through first filter element 34 in a first direction and also as it passes through second filter element 36 in a second direction, which may be substantially opposite the first direction. A flowable mixture may be filtered as it passes from proximal end portion 24 toward distal end portion 26 of filter apparatus 20, rather than merely experiencing frictional losses as it passes from a proximal end portion to a distal end portion, as in the case of a filter apparatus that merely directs a flowable mixture through a non-filtering passage from the proximal to the distal end of the filter apparatus.

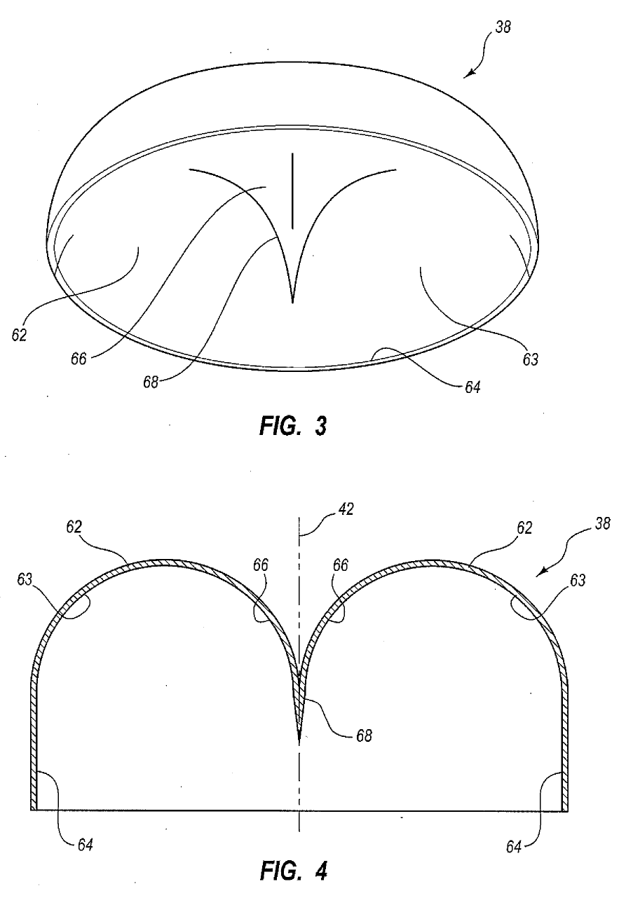

FIGS. 3 and 4 illustrate an exemplary flow deflector 38 according to at least one embodiment. FIG. 3 shows a perspective view of flow deflector 38 and FIG. 4 shows a cross-sectional side view of the flow deflector 38 illustrated in FIG. 3. As illustrated in these figures, flow deflector 38 may comprise an annular trough 62 having an annular concave surface 63 and a protrusion 68.

Flow deflector 38 may be configured to fit within distal end portion 26 of filter apparatus 20 within housing 22, forming a surface portion of deflection chamber 39 (see, e.g., FIG. 2). According to additional embodiments, flow deflector 38 may be attached to housing 22 at distal end portion 26 of filter apparatus 20 through any suitable attachment, such as, for example, by welding flow deflector 38 to housing 22. Annular trough 62 may at least partially extend around a central axis 42 when disposed within filter apparatus 22. Annular concave surface 63 comprising a surface portion of annular trough 62 may be configured to generally face first filter element 34 and/or second filter element 36 when it is disposed within filter apparatus 22. Annular concave surface 63 may be formed to any shape suitable for deflecting a flowable mixture exiting first filter element 34.

According to various embodiments, an outer surface portion 64 of annular concave surface 63 may slope radially outward with respect to central axis 42, as shown in FIGS. 3 and 4. Outer surface portion 64 may follow a curved slope and/or a substantially level slope extending radially outward, with respect to central axis 42, along annular concave surface 63. Additionally, inner surface portion 66 may follow a curved slope and/or a substantially level slope extending radially inward, with respect to central axis 42, along annular concave surface 63. According to certain embodiments, inner surface portion 66 may slope radially inward with respect to central axis 42 to form protrusion 68, as illustrated in FIGS. 3 and 4. Protrusion 68 comprising a portion of flow deflector 38 may extend substantially along central axis 42 toward first filter element 34 and/or second filter element 36. According to at least one embodiment, protrusion 68 may be generally or substantially conical or frusto-conical in shape, the conical or frusto-conical shape having an end portion substantially centered about central axis 42. According to additional embodiments, protrusion 68 may follow a slope substantially inverse to a slope of an end portion of housing 22 at distal end portion 26 of filter apparatus 20.

Flow deflector 38 may substantially reduce turbulent and/or frictional flow losses of a flowable mixture passing through filter apparatus 20. For example, flow deflector 38 may direct a flowable mixture exiting first filter element 34 toward second filter element 36 along a relatively curved path (see, e.g., FIG. 2). The curved path of annular concave surface 63 of flow deflector 38 helps redirect a flowable mixture flowing through filter apparatus with less turbulence, and accordingly less friction, than a distal end portion of housing 22 merely having a flat or concave surface without an annular trough 62 and/or a protrusion 68.

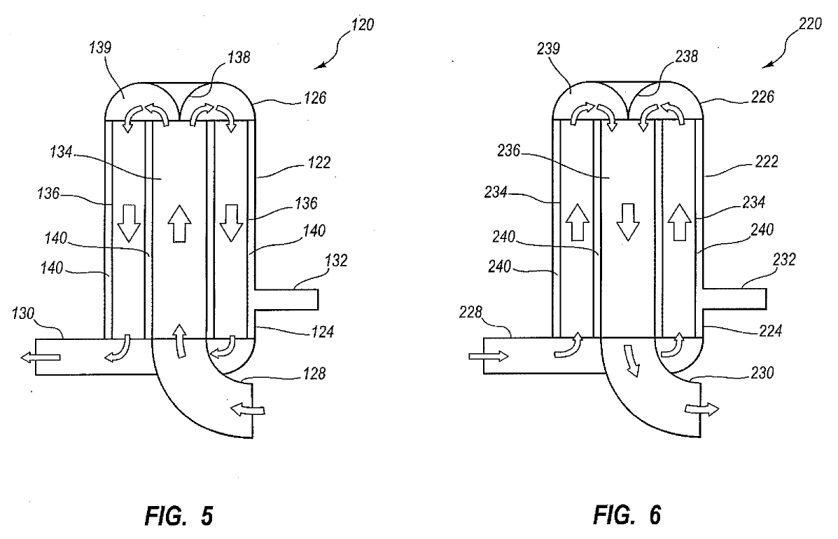

In at least one embodiment, a flowable mixture may flow into deflection chamber 39 from first filter element 34, which is positioned such that central axis 42 runs longitudinally through a substantially central portion of first filter element 34. A significant portion of the flowable mixture exiting first filter element 34 may contact and/or pass near protrusion 68. The portion of the flowable mixture contacting and/or passing near protrusion 68 may be directed outward along and/or near annular concave surface 63 of annular trough 62, being directed from a location at and/or near inner surface portion 66 toward a location at and/or near outer surface portion 66 and subsequently toward second filter element 36 (see, e.g., FIG. 5 below).

According to additional embodiments a flowable mixture may flow into deflection chamber 39 from a first filter element 34 radially surrounding a second filter element 36 that is positioned such that central axis 42 runs longitudinally through a central portion of second filter element 36. A significant portion of the flowable mixture exiting first filter element 34 may contact and/or pass near outer surface portion 64 of annular trough 62. The portion of the flowable mixture contacting and/or passing near outer surface portion 64 may be directed radially inward along and/or near annular concave surface 63 of annular trough 62, being directed from a location at and/or near outer surface portion 66 toward a location at and/or near inner surface portion 66, and subsequently toward second filter element 36 (see, e.g., FIG. 6 below).

FIGS. 5 and 6 illustrate flow paths of a flowable mixture through an exemplary filter apparatus 120 and an exemplary filter apparatus 220 according to various embodiments. As illustrated in FIG. 5, filter apparatus 120 may comprise a housing 122, a proximal end portion 124, a distal end portion 126, a feed inlet 128, a retentate outlet 130, and a permeate outlet 132. In addition, filter apparatus 120 may comprise a first filter element 134, a second filter element 136, a flow deflector 138, and a permeate chamber 140.

According to at least one embodiment, first filter element 134 and/or second filter element 136 may be positioned within housing 122 substantially parallel to a central axis in a longitudinal direction (see, e.g., central axis 42 in FIG. 2). First filter element 134 and/or second filter element 136 may also be positioned about a central axis. For example, first filter element 134 may be positioned such that a central axis runs longitudinally through a central portion of first filter element 134. Additionally, second filter element 136 may be positioned at least partially around first filter element 134. For example, second filter element 136 may radially surround at least a portion of first filter element 134 relative to a central axis of housing 122.

FIG. 5 illustrates a path of a flowable mixture as it flows through filter apparatus 120 from feed inlet 128 to retentate outlet 130 according to at least one embodiment. The path of a flowable mixture as it flows through filter apparatus 120 is generally represented by arrows, as shown in this figure. As a flowable mixture flows through filter apparatus 120, fluid components in the flowable mixture may pass through at least a portion of at least one of first filter element 134 and/or second filter element 136 into permeate chamber 140, exiting through permeate outlet 132. A flowable mixture may therefore be reduced in fluids concentration, and therefore, may be increased in solids concentration as the flowable mixture proceeds through portions of filter apparatus 120. Accordingly, a retentate exiting retentate outlet 130 may comprise a higher solids concentration than a feed mixture entering feed inlet 128.

Apparatus 120 may comprise a central axis (see, e.g., central axis 42 in FIG. 2) and an elongate housing 122 surrounding and/or generally centered around the central axis. First filter element 134 and/or second filter element 136 may be positioned within housing 122 in a longitudinal direction relative to housing 122. According to various embodiments, first filter element 134 may be positioned such that it is located centrally in a longitudinal direction within housing 122. For example, first filter element 134 may be located substantially parallel to and/or substantially centered around a central axis in apparatus 120 (see, e.g., first filter element 34 and central axis 42 in FIG. 2) and/or substantially centered longitudinally within housing 122. Additionally, second filter element 136 may be positioned at least partially around first filter element 134. For example, second filter element 136 may radially surround and/or may be located radially outward from at least a portion of first filter element 134, relative to a central axis in apparatus 120 and/or relative to elongated housing 122.

As illustrated in FIG. 5, a flowable mixture, or feed mixture, may enter filter apparatus 120 at feed inlet 128. The flowable mixture, or feed mixture, may comprise any suitable mixture, including, without limitation, a slurry, a sludge, a liquid mixture, and/or any other suitable fluid and/or solid mixture. The flowable mixture may flow through feed inlet 128 into first filter element 134, which is in fluid communication with feed inlet 128.

The flowable mixture may flow through first filter element 134 in a first longitudinal direction from a proximal end portion 124 to a distal end portion 126 of filter apparatus 120. As the flowable mixture proceeds through first filter element 134, a permeate comprising a fluid portion of the flowable mixture may pass from first filter element 134 into permeate chamber 140 at least partially surrounding first filter element 134. Permeate in permeate chamber 140 may exit filter apparatus 120 through permeate outlet 132, which is in fluid communication with permeate chamber 140. The permeate may comprise a liquid portion from the flowable feed mixture. In additional embodiments, a permeate in permeate chamber 140 may comprise a solution having dissolved solutes. According to various embodiments, various solid portions of the flowable mixture, including solid particles, may be prevented from passing from first filter element 134 into permeate chamber 140 by a porous wall or membrane between an interior of first filter element 134 and permeate chamber 140. According to additional embodiments, solid particles that are smaller than pores in first filter element 134 may pass from an interior of first filter element 134 into permeate chamber 140.

The flowable mixture may flow from a distal end of first filter element 134 into a deflection chamber 139, which is in fluid communication with first filter element 134. Deflection chamber 139 may be located in distal end portion 126 of filter apparatus 120. The flowable mixture exiting first filter element 134 may have a higher solids concentration in comparison with the flowable mixture entering first filter element 134 from feed inlet 128. At least a portion of the flowable mixture flowing from first filter element 134 into deflection chamber 139 may be deflected by a flow deflector 138 (see, e.g., flow deflector 38 in FIGS. 3 and 4) towards second filter element 136, which is in fluid communication with deflection chamber 139. Additionally, at least a portion of the flowable mixture may flow through deflection chamber 139 to second filter element 136 without contacting flow deflector 138. According to various embodiments, flow deflector 138 may deflect the flowable mixture in a radially outward direction relative to elongated housing 122, as illustrated in FIG. 5, toward second filter element 136. Additionally, flow deflector 138 may deflect the flowable mixture in a radially outward direction relative to a central axis of filter apparatus 120 and/or housing 122 (see, e.g., FIG. 2).

The flowable mixture may then flow through second filter element 136 in a second longitudinal direction from distal end portion 126 to proximal end portion 124 of filter apparatus 120. The second longitudinal direction in which the flowable mixture may pass through second filter element 136 may be substantially opposite the first longitudinal direction in which the flowable mixture passed through first filter element 134. As the flowable mixture proceeds through second filter element 136, a permeate comprising a fluid portion of the flowable mixture may pass from second filter element 136 into permeate chamber 140 at least partially surrounding second filter element 136.

According to at least one embodiment, permeate chamber 140 may at least partially surround one or both of first filter element 134 and second filter element 136. Accordingly, a permeate entering permeate chamber 140 from second filter element 136 may mix with a permeate entering permeate chamber 140 from first filter element 134. According to various embodiments, a permeate in permeate chamber 140 may comprise a solution having dissolved solutes. Additionally, solid portions of the flowable mixture, such as solid particles, may be prevented from passing from an interior of second filter element 136 into permeate chamber 140 by a porous wall or membrane between second filter element 136 and permeate chamber 140. According to additional embodiments, solid particles that are smaller than pores in second filter element 136 may pass from an interior of second filter element 136 into permeate chamber 140. A permeate in permeate chamber 140 from first filter element 134 and/or second filter element 136 may exit filter apparatus 120 through permeate outlet 132.

The flowable mixture may subsequently flow from a proximal end of second filter element 136 into retentate outlet 130, which is in fluid communication with second filter element 136. Retentate outlet 130 may be located in proximal end portion 124 of filter apparatus 120 and may be open to an exterior portion of housing 122. A flowable mixture exiting second filter element 136 may have a higher solids concentration in comparison with a flowable mixture entering second filter element 136 from deflection chamber 139. The flowable mixture, or retentate, may exit filter apparatus 120 at retentate outlet 130. The flowable mixture, or retentate, exiting retentate outlet 130 may have a higher solids concentration then a flowable mixture, or feed mixture, entering feed inlet 128.

FIG. 6 illustrates a path of a flowable mixture as it flows through filter apparatus 220 from feed inlet 228 to retentate outlet 230 according to additional embodiments. As a flowable mixture flows through filter apparatus 220, fluid components in the flowable mixture may pass through at least one of first filter element 234 and/or second filter element 236 into permeate chamber 240 and exiting through permeate outlet 232. A flowable mixture may therefore be reduced in fluids concentration and may be increased in solids concentration as the flowable mixture proceeds through portions of filter apparatus 220. Accordingly, a retentate exiting retentate outlet 230 may comprise a higher solids concentration than a feed mixture entering feed inlet 228.

Apparatus 220 may comprise a central axis (see, e.g., central axis 42 in FIG. 2) and an elongate housing 222 surrounding and/or generally centered around the central axis. First filter element 234 and/or second filter element 236 may be positioned within housing 222 in a longitudinal direction relative to housing 222. According to various embodiments, second filter element 236 may be positioned such that it is located centrally in a longitudinal direction within housing 222. For example, second filter element 236 may be located substantially parallel to and/or substantially centered around a central axis in apparatus 220 and/or substantially centered longitudinally within housing 222. Additionally, first filter element 234 may be positioned at least partially around second filter element 236. For example, first filter element 234 may radially surround and/or may be located radially outward from at least a portion of second filter element 236 relative to a central axis in apparatus 220 and/or relative to elongated housing 222.

As illustrated in FIG. 6, a flowable mixture may flow through filter apparatus 220 in a path substantially opposite a flow path of a flowable mixture flowing through filter apparatus 220 illustrated in FIG. 5. A flowable mixture, or feed mixture, may enter filter apparatus 220 at feed inlet 228. The flowable mixture may flow through feed inlet 228 into first filter element 234, which is in fluid communication with feed inlet 228. The flowable mixture may then flow through first filter element 234 in a first longitudinal direction from proximal end portion 224 to distal end portion 226 of filter apparatus 220. As the flowable mixture proceeds through first filter element 234, a permeate comprising a fluid portion of the flowable mixture may pass from an interior portion of first filter element 234 into permeate chamber 240 at least partially surrounding first filter element 234.

The flowable mixture may subsequently flow from a distal end of first filter element 234 into a deflection chamber 239, which is in fluid communication with first filter element 234. Deflection chamber 239 may be located in distal end portion 226 of filter apparatus 220. At least a portion of the flowable mixture flowing from first filter element 234 into deflection chamber 239 may be deflected by a flow deflector 238 (see also flow deflector 38 in FIGS. 3 and 4) towards second filter element 236, which is in fluid communication with deflection chamber 239. Additionally, at least a portion of the flowable mixture may flow through deflection chamber 239 to second filter element 236 without contacting flow deflector 238. Flow deflector 238 may deflect the flowable mixture in a radially inward direction relative to elongated housing 222, as illustrated in FIG. 6, toward second filter element 236. Additionally, flow deflector 238 may deflect the flowable mixture in a radially inward direction relative to a central axis of filter apparatus 220 and/or housing 222 (see, e.g., FIG. 2).

The flowable mixture may then flow through second filter element 236 in a second longitudinal direction from distal end portion 226 to proximal end portion 224 of filter apparatus 220. The second longitudinal direction in which the flowable mixture passes through second filter element 136 may be substantially opposite the first longitudinal direction in which the flowable mixture passes through first filter element 234. As the flowable mixture proceeds through second filter element 236, a permeate comprising a fluid portion of the flowable mixture may pass from second filter element 236 into permeate chamber 240 at least partially surrounding second filter element 236. According to at least one embodiment, permeate chamber 240 may at least partially surround one or both of first filter element 234 and second filter element 236. Accordingly, a permeate entering permeate chamber 240 from second filter element 236 may mix with a permeate entering permeate chamber 240 from first filter element 234. A permeate in permeate chamber 240 from first filter element 234 and/or second filter element 236 may exit filter apparatus 220 through permeate outlet 232.

The flowable mixture may flow from a proximal end of second filter element 236 into retentate outlet 230, which is in fluid communication with second filter element 236. Retentate outlet 230 may be located in proximal end portion 224 of filter apparatus 220 and may be open to an exterior portion of housing 222. The flowable mixture, or retentate, may exit filter apparatus 220 at retentate outlet 230. The flowable mixture, or retentate, exiting retentate outlet 23Q may have a higher solids concentration then a flowable mixture, or feed mixture, entering feed inlet 228.

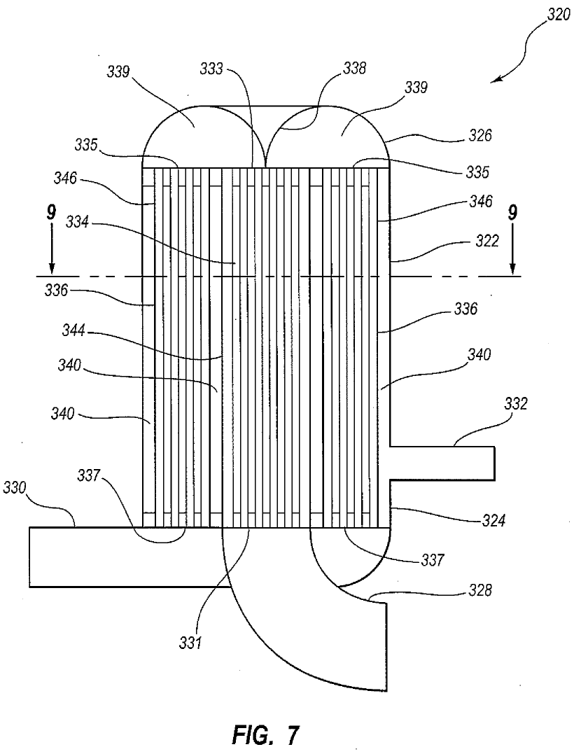

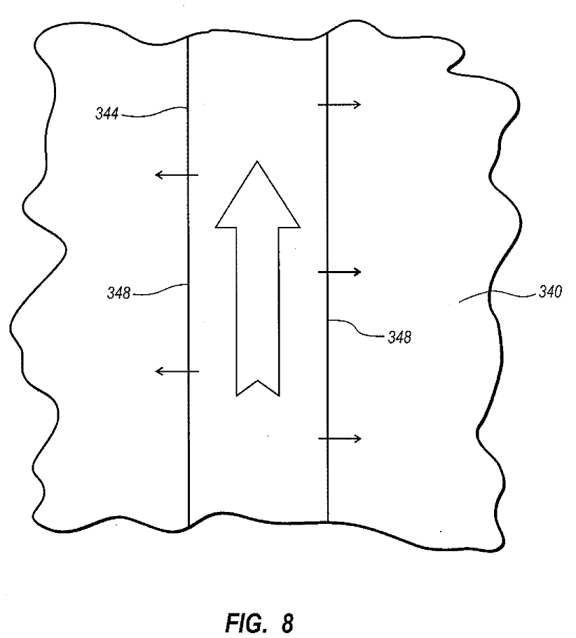

FIG. 7 is an exemplary filter apparatus 320 according to at least one embodiment. As illustrated in this figure, filter apparatus 320 may comprise a housing 322, a proximal end portion 324, a distal end portion 326, a feed inlet 328, a retentate outlet 330, and a permeate outlet 332. In addition, filter apparatus 320 may comprise a first filter element 334, a second filter element 336, and a flow deflector 338. According to additional embodiments, at least a portion of first filter element 334 and/or second filter element 336 may be surrounded by a permeate chamber 340. Additionally, a deflection chamber 339 may be located in distal end portion 326, as shown. Flow deflector 338 may comprise at least a portion of deflection chamber 339.

First filter element 334 may additionally comprise a first filter inlet portion 331 located at or near proximal end portion 324 of filter apparatus 320 and a first filter outlet portion 333 located at or near distal end portion 326 of filter apparatus 320. Further, second filter element 336 may comprise a second filter inlet portion 335 located at or near distal end portion 326 of filter apparatus 320 and a second filter outlet portion 337 located at or near proximal end portion 324 of filter apparatus 320.

According to various embodiments, first filter element 334 may comprise one or more filter tubes 344, as illustrated in FIG. 7. Similarly, second filter element 336 may comprise one or more filter tubes 346. Filter tubes 344, 346 may comprise porous filter tubes having porous walls and/or porous membranes. Filter tubes 344, 346 may allow a flowable mixture to pass longitudinally through a hollow central portion of filter tubes 344, 346. As a flowable mixture passes longitudinally through filter tubes 344, 346, a fluid portion of the flowable mixture may pass from the flowable mixture into permeate chamber 340 and out through permeate outlet 332. In addition, permeate chamber 340 may surround and/or extend between filter tubes 344 and/or filter tubes 346, exposing a relatively large surface area of filter tubes 344 and/or filter tubes 346 to permeate chamber 340. According to certain embodiments, first filter inlet portion 331 and/or first filter outlet portion 333 may comprise one or more openings allowing passage of a flowable mixture into and/or out of end portions of each of the one or more filter tubes 344 forming at least a portion of first filter element 334. Similarly, second filter inlet portion 335 and/or second filter outlet portion 337 may comprise one or more openings allowing passage of a flowable mixture into and/or out of end portions of each of the one or more filter tubes 346 forming at least a portion of second filter element 334.

According to at least one embodiment, filter tubes 344 and/or filter tubes 346 may extend longitudinally between proximal end portion 324 and distal end portion 326 of filter apparatus 320. Additionally, one or more filter tubes 344 and/or one or more filter tubes 346 may be positioned such that they are substantially parallel to one another and/or a central axis of filter apparatus 320 (see, e.g., central axis 42 in FIG. 2). According to additional embodiments, filter tubes 344 and/or filter tubes 346 may be spaced apart from one another, as shown in FIG. 7, allowing permeate exiting filter tubes 344 and/or filter tubes 346 to readily flow into permeate chamber 340. For example, positioning filter tubes 344 and/or filter tubes 346 such that they are spaced apart from one another may enable a relatively larger surface area of the walls of filter tubes 344 and/or filter tubes 346 to be exposed to permeate chamber 340.

Each of filter tubes 344, 346 may be formed to any suitable diameter, length, and shape. For example, increasing the number of filter tubes 344 and/or filter tubes 346 in filter apparatus 320 may increase the overall surface area of filter tubes 344 and/or filter tubes 346 exposed to permeate chamber 340. Additionally, relatively larger diameter filter tubes 344 and/or filter tubes 346 may facilitate passage of a flowable mixture through central portions of filter tubes 344 and/or filter tubes 346. According to additional embodiments, filter apparatus 320 may comprise a number of filter tubes 344 that is equivalent to the number of filter tubes 346. Similarly, filter tubes 344 may be capable of enclosing a volume of a flowable mixture that is substantially equivalent to a volume of a flowable mixture that filter tubes 346 are capable of enclosing.

FIG. 8 illustrates an exemplary section of a filter tube 344 surrounded by a permeate chamber 340. Filter tubes 346 may be formed and may operate in substantially the same manner as filter tube 344 illustrated in this figure. As shown in this FIG. 8, filter tube 344 may comprise a porous wall 348. A flowable mixture may pass through an interior of filter tube 344. For example, a flowable mixture may pass in a generally longitudinal direction through a hollow interior portion of filter tube 344 defined by porous wall 348, as represented in FIG. 8. Porous wall 348 may comprise a filter wall or membrane having pores sized to allow passage of fluids through the filter wall or membrane while preventing passage of solid particles having diameters larger than the pore diameters. In certain embodiments, porous wall 348 may have pores sized to allow passage of dissolved solutes and solid particles having diameters smaller than diameters of pores in porous wall 348.

Porous wall 348 may separate a flowable mixture passing through a hollow interior portion of filter tube 344 and permeate chamber 340. A fluid portion of a flowable mixture passing through filter tube 344 may be capable of passing through pores in the porous wall 348 into permeate chamber 340, as represented by arrows in FIG. 8 that extend through porous wall 348 from an interior of filter tube 344 to permeate chamber 340. According to various embodiments, porous wall 348 may comprise pores sized to prevent solid portions of a flowable mixture, such as various solid particles, from passing through the pores into permeate chamber 340. In additional embodiments, permeate passing through pores in porous wall 348 into permeate chamber 340 may comprise dissolved solutes and/or solid particles having diameters that are smaller than diameters of pores in porous wall 348. Accordingly, as a flowable mixture passes through filter tube 344, a fluid portion of the flowable mixture, or permeate, may be separated from a solid portion and/or remaining fluid portion of the flowable mixture flowing through an interior of filter tube 344. As mentioned, the permeate may include certain dissolved solutes and/or solid particles small enough to pass through pores in porous wall 348. Therefore, as a flowable mixture passes through filter tube 344, the flowable mixture may become more concentrated in solids content.

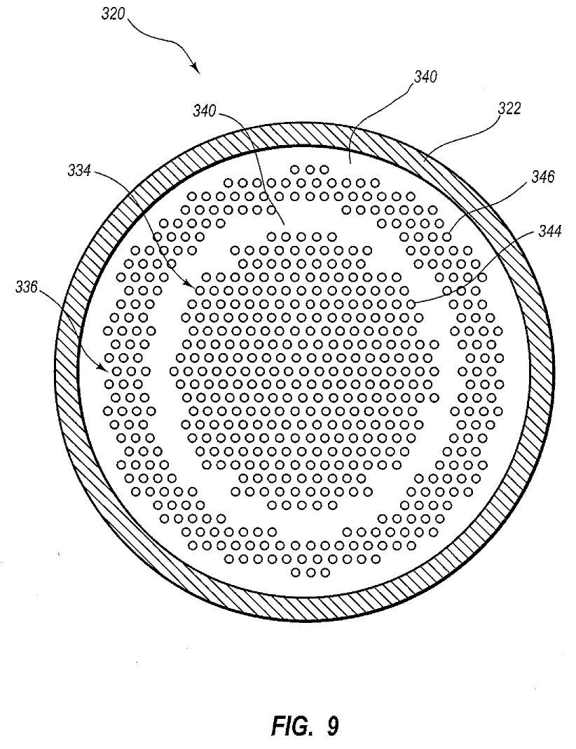

FIG. 9 is a cross-sectional top view of an exemplary filter apparatus 320 taken along line 9-9 shown in FIG. 7. As illustrated in FIG. 9, filter apparatus 320 may comprise a housing 322, a permeate chamber 340, a first filter element 334 comprising a plurality of filter tubes 344, and a second filter element 336 comprising a plurality of filter tubes 346. Permeate chamber 340 may be defined by an interior of housing 322. Additionally, permeate chamber 340 may at least partially surround first filter element 334 and/or second filter element 336. Permeate chamber 340 may also extend through and/or surround portions of first filter element 334 and/or second filter element 336. For example, as shown in FIG. 9, permeate chamber 340 may extend through first filter element 334 and second filter element 336, extending between and at least partially surrounding individual filter tubes 344, 346, facilitating passage of a permeate from an interior of filter tubes 344, 346 to permeate chamber 340.

According to various embodiments, first filter element 334 comprising filter tubes 344 and/or second filter element 336 comprising filter tubes 346 may also be positioned about a central axis extending longitudinally through a substantially central portion of filter apparatus 320. For example first filter element 334 may be positioned such that it may surround a central axis longitudinally extending through a central portion of filter apparatus 320 and/or housing 322 (see, e.g., central axis 42 in FIG. 2). As illustrated in FIG. 9, a plurality filter tubes 344 forming at least a portion of first filter element 334 may be positioned within housing 322 in a radially central portion of filter apparatus 320. In additional embodiments, second filter element 336 may be positioned within housing 322 radially surrounding at least a portion of first filter element 334, as illustrated in FIG. 9. A plurality filter tubes 346 forming at least a portion of second filter element 336 may be positioned within housing 322 radially surrounding filter tubes 344 forming at least a portion of first filter element 334. According to additional embodiments, second filter element 336 may be positioned such that it is positioned within housing 322 in a radially central portion of filter apparatus 320 and such that first filter element 334 radially surrounds second filter element 336.

Additionally, as shown in FIG. 9, filter tubes 344 and/or filter tubes 346 may be spaced apart from one another, allowing permeate exiting filter tubes 344 and/or filter tubes 346 to readily flow into permeate chamber 340. For example, positioning filter tubes 344 and/or filter tubes 346 such that they are spaced apart from one another may enable a relatively larger surface area of porous walls 348 (see, e.g., FIG. 8) of filter tubes 344 and/or filter tubes 346 to be exposed to permeate chamber 340.

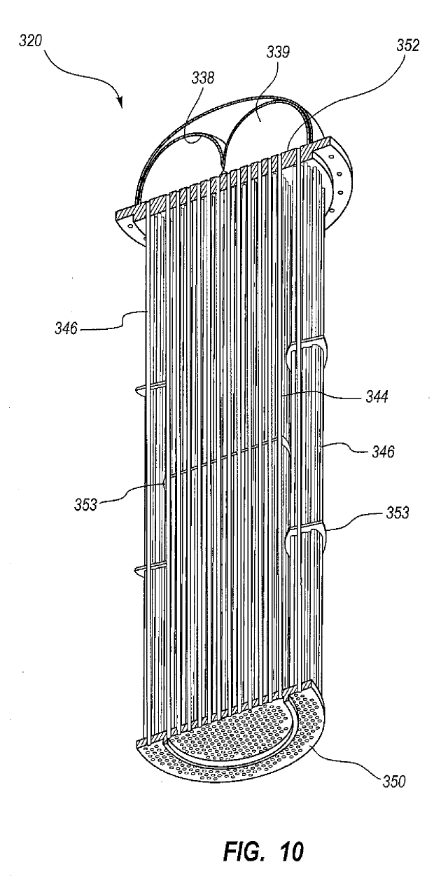

FIG. 10 shows portions of an exemplary filter apparatus 320 according to at least one embodiment. Filter apparatus 320 may include a first filter element 334 comprising filter tubes 344 and a second filter element 336 comprising filter tubes 346 (see, e.g., FIGS. 7 and 9). Filter apparatus 320 may include a flow deflector 338. In addition, filter apparatus 320 may include a proximal tubesheet 350 and a distal tubesheet 352. Filter tubes 344, 346 may extend longitudinally between proximal end portion 324 and distal end portion 326 of filter apparatus 320 (see, e.g., FIG. 7). Additionally, one or more filter tubes 344 and/or filter tubes 346 may be positioned such that they are substantially parallel to one another and/or a central axis of filter apparatus 320 (see, e.g., central axis 42 in FIG. 2). According to additional embodiments, filter tubes 344 and/or filter tubes 346 may be spaced apart from one another, as shown in FIG. 10. Further, filter tubes 344 and/or filter tubes 346 may be supported and/or maintained at a separation distance from each other with one or more brace members 353. Brace members 353 may comprise any suitable members configured to surround and/or fit between one or more filter tubes 344 and/or filter tubes 346.

Additionally, as illustrated in FIG. 10, filter tubes 344 and/or filter tubes 346 may be connected to proximal tubesheet 350 and/or distal tubesheet 352. For example, proximal ends of filter tubes 344 and/or filter tubes 346 may be connected to proximal tubesheet 350 and distal ends of filter tubes 344 and/or filter tubes 346 may be connected to distal tubesheet 352. According to various embodiments, filter tubes 344 and/or filter tubes 346 may be connected to proximal tubesheet 350 and/or distal tubesheet 352 at holes extending through proximal tubesheet 350 and/or distal tubesheet 352. For example, as shown in FIG. 10, filter tubes 344 and/or filter tubes 346 may at least partially extend through holes defined in proximal tubesheet 350 and/or distal tubesheet 352.

According to at least one embodiment, proximal tubesheet 350 and/or distal tubesheet 352 may comprise surfaces defining at least a portion of permeate chamber 340. Additionally, proximal tubesheet 350 may define at least an interior surface portion of proximal end portion 324 of filter apparatus 320, including interior surface portions of feed inlet 328 and/or and retentate outlet 330 (see, e.g., FIG. 7). Likewise, distal tubesheet 352 may define at least an interior surface portion of distal end portion 326 of filter apparatus 320, including, for example, an interior surface portion of deflection chamber 339. In addition, proximal tubesheet 350 may be located adjacent to and/or may define at least a portion of first filter inlet portion 331 and/or second filter outlet portion 337 (see, e.g., FIG. 7). Similarly, distal tubesheet 352 may be located adjacent to and/or may define at least a portion of first filter outlet portion 333 and/or second filter inlet portion 335.

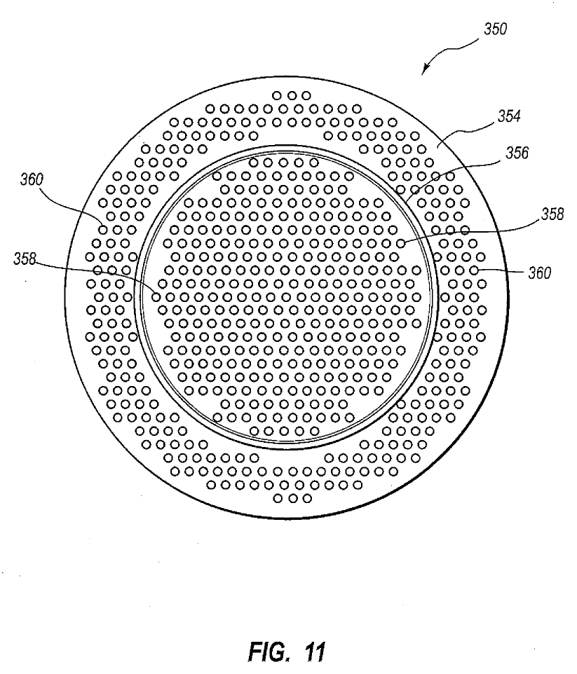

FIG. 11 is a bottom view of an exemplary proximal tubesheet 350 according to at least one embodiment. Distal tubesheet 352 may comprise a substantially similar or identical configuration to proximal tubesheet 350 illustrated in this figure. As shown in FIG. 11, proximal tubesheet 350 may comprise a tubesheet surface 354, and one or more filter holes 358, 360. Filter holes 358, 360 may be configured to connect to filter tubes 344, 346. For example, filter holes 358 may be configured to connect to one or more filter tubes 344 and/or filter holes 360 may be configured to connect to connect to one or more filter tubes 346 (see, e.g., FIG. 10). Filter holes 358 and/or filter holes 360 may be configured to connect to filter tubes 344 and/or filter tubes 346 through any suitable connection. For example, filter tubes 344 and/or filter tubes 346 may be inserted at least partially into and/or through filter holes 358 and/or filter holes 360.

Additionally, as illustrated in FIG. 11, a plurality of filter holes 360 may be formed in proximal tubesheet 350 such that filter holes 360 radially surround at least a portion of a plurality of filter holes 358 formed in proximal tubesheet 350. According to additional embodiments, a plurality of filter holes 358 may be formed in proximal tubesheet 350 such that filter holes 358 radially surround at least a portion of a plurality of filter holes 360 formed in proximal tubesheet 350. According to certain embodiments, proximal tubesheet 350 may also comprise a collar 356. Collar 356 may at least partially separate a flowable mixture flowing through filter holes 358 and/or filter tubes 344 from a flowable mixture flowing through filter holes 360 and/or filter tubes 346. According to various embodiments, collar 356 may coincide with and/or form a portion of a wall and/or surface separating feed inlet 328 from retentate outlet 330. According to additional embodiments, collar 356 may be connected to feed inlet 328.

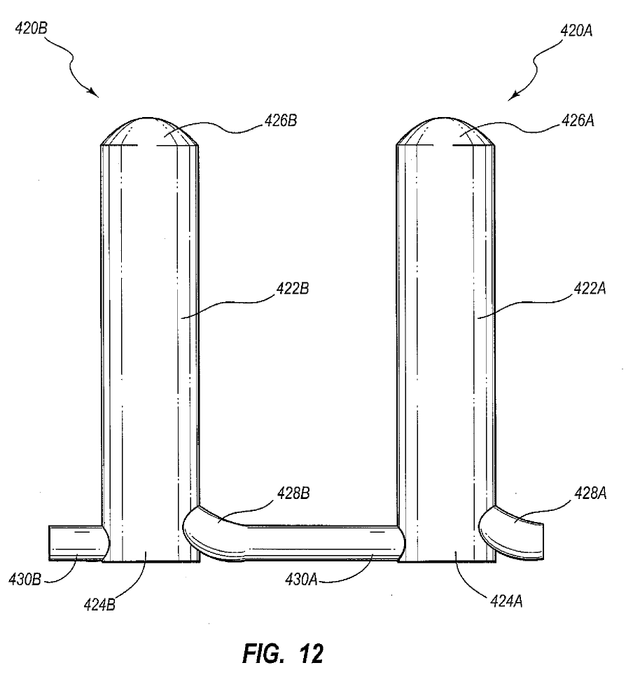

FIG. 12 shows exemplary filter apparatus 420A and exemplary filter apparatus 420B connected in series according to at least one embodiment. For example, as illustrated in this figure, filter apparatus 420A may be connected in series with filter apparatus 420B. Filter apparatus 420A may comprise a proximal end portion 424A, a distal end portion 426A, a housing 422A, a feed inlet 428A, and a retentate outlet 430A. Likewise, filter apparatus 420B may comprise a proximal end portion 424B, a distal end portion 426B, a housing 422B, a feed inlet 428B, and a retentate outlet 430B. Each of filter apparatus 420A and filter apparatus 420B may also comprise permeate outlets (see, e.g., FIG. 1). As additionally illustrated in FIG. 12, retentate outlet 430A of filter apparatus 420A may be connected to a feed inlet 428B of filter apparatus 420B connected in series with filter apparatus 420A.

Two or more filter apparatuses, such as filter apparatus 420A and filter apparatus 420B, may be connected to each other in any suitable configuration. According to at least one embodiment, filter apparatus 420A may have a configuration such that a flowable mixture entering feed inlet 428A may flow through filter apparatus 420A in a flow pattern similar to that shown in FIG. 5. For example, a flowable mixture may pass from proximal end portion 424A to distal end portion 426A of filter apparatus 420A through a first filter element positioned centrally within filter apparatus 420A (see, e.g., first filter element 134 in FIG. 5). In addition, as similarly shown in FIG. 5, a flowable mixture may then flow from distal end portion 426A to proximal end portion 424A of filter apparatus 420A through a second filter element positioned radially outward with respect to the first filter element (see, e.g., first filter element 134 and second filter element 136 in FIG. 5).

In addition, filter apparatus 420B, which may be connected in series to filter apparatus 420A as shown in FIG. 12, may have a configuration such that a flowable mixture may flow through filter apparatus 420B in a flow pattern similar to that shown in FIG. 6. For example, a flowable mixture exiting filter apparatus 420A from retentate outlet 430A may enter filter apparatus 420B at feed inlet 428B. A flowable mixture entering feed inlet 428B of filter apparatus 420B may flow from proximal end portion 424B to distal end portion 426B of filter apparatus 420B through a first filter element that is positioned radially outward with respect to a second filter element (see, e.g., first filter element 234 and second filter element 236 in FIG. 6). In addition, as similarly shown in FIG. 6, a flowable mixture may flow from distal end portion 426B to proximal end portion 424B of filter apparatus 420B through a second filter element positioned centrally within filter apparatus 420B, and positioned radially inward with respect to the first filter element (see, e.g., first filter element 234 and second filter element 236 in FIG. 6).

According to certain embodiments, filter apparatus 420A and filter apparatus 420B may both have a configuration such that a flowable mixture may flow through filter apparatus 420A and filter apparatus 420B in a flow pattern similar to that shown in FIG. 5. According to additional embodiments, filter apparatus 420A and filter apparatus 420B may both have a configuration such that a flowable mixture may flow through filter apparatus 420A and filtering apparatus 420B in a flow pattern similar to that shown in FIG. 6.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A filter assembly, comprising:
a first filter element comprising an elongated member having an inlet portion and an outlet portion;
a second filter element comprising an elongated member having an inlet portion and an outlet portion, wherein the second filter element is laterally adjacent the first filter element;
a flow deflector configured to deflect a flowable mixture exiting the outlet portion of the first filter element toward the inlet portion of the second filter element;
a permeate chamber surrounding at least a portion of at least one of the first filter element and the second filter element.

2. The filter assembly of claim 1, wherein the permeate chamber is configured to receive a permeate from a flowable mixture in at least one of the first filter element and the second filter element.

3. The filter assembly of claim 1, wherein at least one of the first filter element and the second filter element comprises one or more filter tubes.

4. The filter assembly of claim 3, wherein the one or more filter tubes comprise one or more porous tubes.

5. The filter assembly of claim 4, wherein the one or more filter tubes are configured to convey a flowable mixture through an interior of the one or more filter tubes.

6. The filter assembly of claim 4, wherein the one or more porous tubes comprise pores sized to prevent solid particles having a diameter larger than a diameter of the pores from passing through the pores.

7. The filter assembly of claim 4, wherein the one or more porous tubes comprise pores sized such that a permeate from a flowable mixture may pass from an interior of the one or more porous tubes into the permeate chamber.

8. The filter assembly of claim 1, further comprising a permeate outlet connected to the permeate chamber.

9. The filter assembly of claim 1, wherein the first filter element is configured to convey a flowable mixture in a first direction and the second filter element is configured to convey a flowable mixture in a second direction substantially opposite the first direction.

10. The filter assembly of claim 1, wherein the second filter element at least partially surrounds the first filter element.

11. A filter assembly, comprising:
a proximal end portion;
a distal end portion;
a feed inlet located at the proximal end portion;
a first filter element in fluid communication with the feed inlet, the first filter element extending between the proximal end portion and the distal end portion;
a second filter element in fluid communication with the first filter element, the second filter element extending between the distal end portion and the proximal end portion;
a flow deflector located at the distal end portion, the flow deflector being configured to deflect a flowable mixture exiting the first filter element toward the second filter element;
a retentate outlet located at the proximal end portion, the retentate outlet being in fluid communication with the second filter element.

12. The filter assembly of claim 11, further comprising a permeate chamber surrounding at least a portion of at least one of the first filter element and the second filter element, wherein the permeate chamber is configured to receive a permeate from at least one of the first filter element and the second filter element.

13. The filter assembly of claim 11, wherein at least one of the first filter element and the second filter element comprises one or more porous tubes having pores sized to prevent solid particles having a diameter larger than a diameter of the pores from passing through the pores.

14. The filter assembly of claim 11, wherein a flowable mixture exiting the retentate outlet has a higher solids concentration than a flowable mixture entering the feed inlet.

15. The filter assembly of claim 11, wherein the flow deflector comprises an annular trough having an annular concave surface open to the first filter element and the second filter element.

16. The filter assembly of claim 11, wherein the retentate outlet is located in close proximity to the feed inlet.

17. A filter assembly, comprising:
a first plurality of porous tubes configured to convey a flowable mixture in a first direction;
a second plurality of porous tubes in fluid communication with the first plurality of porous tubes, wherein the second plurality of porous tubes is configured to convey the flowable mixture in a second direction;
a flow deflector configured to deflect a flowable mixture exiting the first plurality of porous tubes toward the second plurality of porous tubes;
a permeate chamber surrounding at least a portion of at least one of the first plurality porous tubes and the second plurality of porous tubes, the permeate chamber being configured to convey a permeate from at least one of the first plurality of porous tubes and the second plurality of porous tubes.

18. The filter assembly of claim 17, wherein each of the first plurality of porous tubes is substantially parallel to each of the second plurality of porous tubes.

19. The filter assembly of claim 18, wherein the first plurality of porous tubes is grouped about a central axis, and wherein each of the second plurality of porous tubes is positioned radially outward relative to the first plurality of porous tubes.

20. The filter assembly of claim 18, wherein the second plurality of porous tubes is grouped about a central axis, and wherein each of the first plurality of porous tubes is positioned radially outward relative to the second plurality of porous tubes.

21. The filter assembly of claim 17, wherein at least one of the first plurality of porous tubes and the second plurality of porous tubes comprises pores sized to prevent solid particles having a diameter larger than a diameter of the pores from passing through the pores.

22. The filter assembly of claim 17, wherein the first direction is substantially opposite the second direction.

23. A filter assembly, comprising:
an elongated housing having a central axis, a proximal end portion, and a distal end portion, the elongate housing comprising:
a first filter element positioned in the elongate housing about the central axis;
a second filter element positioned in the elongate housing such that at least part of the second filter element surrounds the first filter element in a radial direction relative to the central axis;
a deflection chamber in the distal end portion between an end surface of the elongate housing and each of the first filter element and the second filter element;
a flow deflector positioned in the deflection chamber, the flow deflector being configured to deflect a flowable mixture from the first filter element toward the second filter element.

24. The filter assembly of claim 23, wherein the flow deflector comprises an annular trough having an annular concave surface open to the first filter element and the second filter element.

25. The filter assembly of claim 24, wherein an outer portion of the annular concave surface slopes radially outward with respect to the central axis, and wherein an inner portion of the annular concave surface slopes radially inward with respect to the central axis to form a protrusion.

26. The filter assembly of claim 25, wherein the protrusion is generally conical in shape.

27. The filter assembly of claim 23, further comprising a permeate chamber surrounding at least a portion of at least one of the first filter element and the second filter element.

28. The filter assembly of claim 23, wherein a flow is conveyed through the first filter element in a first direction and the flow is conveyed through the second filter element in a direction substantially opposite the first direction.

29. The filter assembly of claim 23, wherein the flow deflector is configured to deflect a flow from the second filter element toward the first filter element.

30. A method of removing liquid from a flowable mixture, comprising:
conveying the flowable mixture through a first filter element in a first direction;
deflecting the flowable mixture exiting the first filter element toward a second filter element inlet;
conveying the flowable mixture through the second filter element in a second direction substantially opposite the first direction;
conveying a permeate from the flowable mixture through a porous surface of at least one of the first filter element and the second filter element into a permeate chamber surrounding at least a portion of at least one of the first filter element and the second filter element.

31. The method of claim 30, further comprising introducing the flowable mixture into the first filter element through a feed inlet.

32. The method of claim 31, further comprising discharging the flowable mixture from the second filter element through a retentate outlet, wherein the retentate outlet is positioned in close proximity to the feed inlet.

33. The method of claim 30, wherein at least one of the first filter element and the second filter element comprises one or more porous tubes.

34. The method of claim 30, wherein the flowable mixture is a slurry.
